(19) United States
(12) Patent Application Publication
(10) Pub. No.: US 2019/0143954 A1
(43) Pub. Date: May 16, 2019

(54) CONTROLLER FOR INTERNAL COMBUSTION ENGINE

(71) Applicant: TOYOTA JIDOSHA KABUSHIKI KAISHA, Toyota-shi (JP)

(72) Inventor: Yuki BISAIJI, Toyota-shi (JP)

(73) Assignee: TOYOTA JIDOSHA KABUSHIKI KAISHA, Toyota-shi (JP)

(21) Appl. No.: 16/144,031

(22) Filed: Sep. 27, 2018

(30) Foreign Application Priority Data
Nov. 10, 2017 (JP) 2017-217585

(51) Int. Cl. B60W 10/08; B60L 11/14; B60W 10/30; B60W 20/15; F01N 3/025; F01N 3/20

(52) U.S. Cl. CPC B60W 10/08; B60L 11/14; B60W 10/30; F01N 3/30; F01N 3/0256; F01N 3/2066; B60W 20/15

(57) ABSTRACT

A controller for an internal combustion engine is configured to be used in a vehicle to control the vehicle. The vehicle includes an internal combustion engine that is provided with an exhaust purifier and a generator that converts rotation power of a crankshaft of the internal combustion engine into electric power. The exhaust purifier includes a heater configured to generate heat by consuming electric power, a filter configured to collect particulate matter from an exhaust gas, and a catalyst arranged at an upstream side or downstream side of the filter and subjected to heating by the heater. The controller is configured to perform an increase process for increasing electric power generated by the generator by increasing electric power consumed by the heater on condition that a regeneration request for the filter is issued.

### CROSS REFERENCE TO RELATED APPLICATION

This application claims priority from Japanese Patent Application No. 2017-217585, filed on Nov. 10, 2017, the disclosure of which is incorporated herein by reference in its entirety.

### BACKGROUND

The present disclosure relates to a controller for an internal combustion engine applied to a vehicle including the internal combustion engine, which is provided with an exhaust purifier, and a generator, which is connected to a crankshaft of the internal combustion engine. Specifically, the present disclosure relates to a controller for an internal combustion engine, in which the exhaust purifier includes a heater that generates heat by consuming electric power, a filter that collects particulate matter from an exhaust gas, and a catalyst arranged at the upstream or downstream side of the filter and subjected to heating by the heater.

Japanese Laid-Open Patent Publication No. 2012-102684 discloses an exhaust purifier for purifying an exhaust gas. The exhaust purifier includes a filter for collecting particulate matter from the exhaust gas and a selective catalytic reduction catalyst arranged at the downstream side of the filter. The publication also discloses a controller that performs a filter regeneration process to burn particulate matter by raising the exhaust temperature if the amount of the particulate matter collected in the filter is large and clogging may thus occur. Specifically, the exhaust temperature is raised by decreasing the cross-sectional area of an exhaust passage at the downstream side of the filter and narrowing the exhaust passage. Further, in addition to the narrowing of the exhaust passage, the fuel injection amount is increased in the publication. Refer to Japanese Laid-Open Patent Publication No. 2012-102684, paragraph [0047].

As mentioned above, the exhaust temperature is raised when the exhaust passage is narrowed. However, when the internal combustion engine is operated under a low load, even if the exhaust passage is narrowed, it is difficult to heat the filter to a temperature suitable for the regeneration process. Further, an increase in the fuel injection amount to perform the filter regeneration process will result in an increase in the torque of the internal combustion engine.

### SUMMARY

### Example 1

A controller for an internal combustion engine according to one aspect is configured to be used in a vehicle to control the vehicle. The vehicle includes an internal combustion engine that is provided with an exhaust purifier and a generator that converts rotation power of a crankshaft of the internal combustion engine into electric power. The exhaust purifier includes a heater configured to generate heat by consuming electric power, a filter configured to collect particulate matter from an exhaust gas, and a catalyst arranged at an upstream side or downstream side of the filter and subjected to heating by the heater. The controller is configured to perform an increase process that increases electric power generated by the generator by increasing electric power consumed by the heater on condition that a regeneration request for the filter is issued.

In the above configuration, on condition that a regeneration request for the filter is issued, a greater load torque is applied by the generator to the internal combustion engine by increasing the electric power consumed by the heater to increase the generated electric power than when the regeneration request is not issued. This increases the load on the internal combustion engine while limiting increases in the torque required for devices other than the generator and consequently raises the exhaust temperature. This allows the filter to be heated to a temperature suitable for the regeneration process.

### Example 2

The controller according to Example 1, wherein the catalyst is arranged at the downstream side of the filter, and the heater is arranged between the filter and the catalyst.

In the above configuration, when the electric power consumed by the heater is increased, the exhaust temperature at the downstream side of the heater is raised. However, the exhaust temperature at the upstream side of the heater is not raised like the downstream side. Thus, a rise in the exhaust temperature resulting from an increase in the electric power consumed by the heater hardly raises the temperature of the filter.

### Example 3

The controller according to Example 2, wherein the catalyst is a selective catalytic reduction catalyst configured to reduce NOx. The controller is configured to perform a temperature adjustment process that supplies electric power to the heater in order to control a temperature of the selective catalytic reduction catalyst within a first temperature range in a case in which the temperature of the selective catalytic reduction catalyst is lower than the first temperature range. The increase process includes controlling the temperature of the selective catalytic reduction catalyst to be higher than the first temperature range.

A NOx reduction rate of the selective catalytic reduction catalyst falls if the temperature is excessively low. In the above configuration, the temperature adjustment process is performed to promptly overcome a situation where the NOx reduction rate is low because of the low temperature of the selective catalytic reduction catalyst. Further, in the above configuration, the increase process raises the temperature of the selective catalytic reduction catalyst to a value higher than that of the temperature adjustment process. Thus, more electric power is consumed by the heater than when the temperature is controlled in the first temperature range.

### Example 4

The controller according to Example 3, wherein the controller is configured to be prohibited from performing the increase process in a case in which the temperature of the selective catalytic reduction catalyst is higher than or equal to a specified temperature, which is higher than the first temperature range.

The NOx reduction rate falls if the temperature of the selective catalytic reduction catalyst is excessively high. In the above configuration, if the temperature of the selective catalytic reduction catalyst is higher than or equal to the specified temperature, by prohibiting the increase process, that is, by not performing the increase process, the temperature by which the NOx reduction rate becomes outstanding is set to the specified temperature. This limits decreases in the NOx reduction rate of the selective catalytic reduction catalyst.

### Example 5

The controller according to any one of Examples 1 to 4, wherein the generator includes a motor generator that is configured to assist torque for assisting torque of the internal combustion engine.

In the above configuration, the motor generator is used to compensate for an increase in the electric power consumed by the heater. The motor generator tends to have a large output because it is configured to assist torque. Thus, the load torque applied to the crankshaft is easily increased.

Other aspects and advantages of the present disclosure will become apparent from the following description, taken in conjunction with the accompanying drawings, illustrating exemplary embodiments.

### BRIEF DESCRIPTION OF THE DRAWINGS

The disclosure may be understood by reference to the following description together with the accompanying drawings:

FIG. 1 is a diagram illustrating a driving system of a vehicle including a controller for an internal combustion engine according to one embodiment;

FIG. 2 is a block diagram illustrating some of the processes performed by the controller according to the embodiment;

FIG. 3 is a time chart illustrating changes in running power and regenerative power obtained in a running/regenerative power calculation process according to the embodiment;

FIG. 4 is a flowchart illustrating the procedures of an inverter operation process according to the embodiment;

FIG. 5 is a flowchart illustrating the procedures of an EHC driving process according to the embodiment;

FIG. 6 is a graph illustrating the relationship between the temperature of an SCR catalyst and a NOx reduction rate according to the embodiment; and

FIG. 7 is a time chart illustrating EHC driving according to the embodiment.

### DETAILED DESCRIPTION

A controller for an internal combustion engine according to one embodiment will now be described with reference to the drawings.

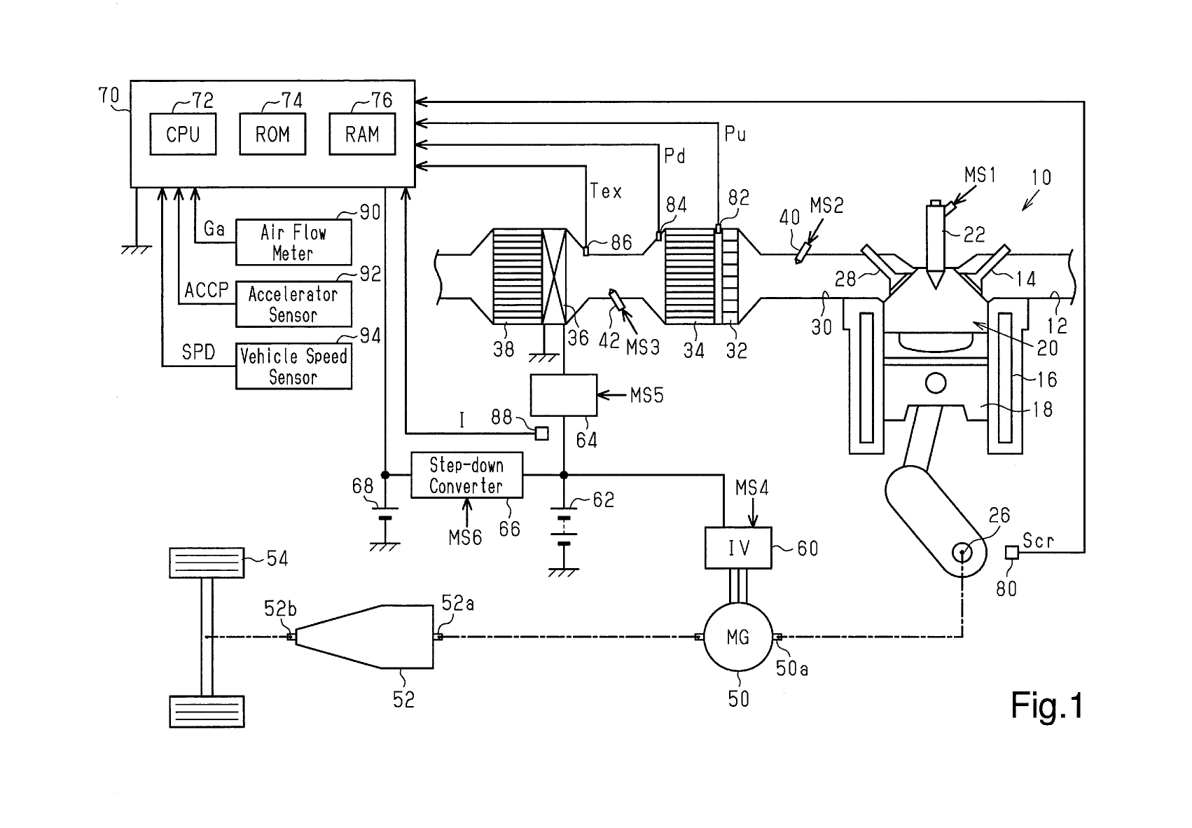

In an internal combustion engine 10 shown in FIG. 1, air drawn into an intake passage 12 flows, as an intake valve 14 opens, into a combustion chamber 20 defined by a cylinder 16 and a piston 18. Fuel such as diesel fuel is injected into the combustion chamber 20 from a fuel injection valve 22. A mixture of air and fuel in the combustion chamber 20 is ignited and burned when compressed in. The energy generated by the combustion of the air-fuel mixture is converted into rotational energy of a crankshaft 26 by the piston 18. The burned mixture is discharged as an exhaust gas into an exhaust passage 30 as an exhaust valve 28 opens.

The exhaust passage 30 includes an oxidation catalyst 32 and a diesel particulate filter (DPF) 34 for collecting particulate matter (hereafter referred to as “PM”) arranged at the downstream side of the oxidation catalyst 32. The exhaust passage 30 also includes a heater, namely, an electrically heated catalyst (hereafter referred to as “EHC”) 36, arranged at the downstream side of the DPF 34. A selective catalytic reduction catalyst (hereafter referred to as “SCR catalyst”) 38 is arranged at the downstream side of the EHC 36. The heated subject of the EHC 36 is the SCR catalyst 38. The EHC 36 is configured to heat the SCR catalyst 38. In the exhaust passage 30, a fuel addition valve 40 for adding fuel to the exhaust gas is arranged at the upstream side of the oxidation catalyst 32. Further, a urea solution addition valve 42 for adding urea solution to the exhaust gas is arranged between the DPF 34 and the EHC 36.

A rotation shaft 50a of a motor generator 50 is mechanically connectable to the crankshaft 26. In the present embodiment, a three-phase rotating electrical machine is used as the motor generator 50. The rotation shaft 50a of the motor generator 50 is mechanically connected to an input shaft 52a of a transmission 52. An output shaft 52b of the transmission 52 is mechanically connected to driving wheels 54.

Voltages of phases in a three-phase inverter 60 are applied to corresponding three-phase terminals of the motor generator 50. The three-phase inverter 60 is a power converter circuit that converts a direct-current voltage of a high-voltage battery 62, which serves as a direct-current voltage supply, into an alternating-current voltage and outputs the resulting voltage. In the present embodiment, the high-voltage battery 62 includes a lithium-ion rechargeable battery. The terminal voltage of the high-voltage battery 62 is, for example, approximately 48 V.

Electric power of the high-voltage battery 62 is supplied to a driving circuit 64 for driving the EHC 36. Further, a step-down converter 66 steps down the voltage of the high-voltage battery 62 and applies the resulting electric power to a low-voltage battery 68. In the present embodiment, the low-voltage battery 68 includes a lead-acid battery. The terminal voltage of the low-voltage battery 68 is, for example, approximately 12 V.

A controller 70 is configured to control the internal combustion engine 10. The controller 70 operates units operated in the internal combustion engine 10 such as the fuel injection valve 22, the driving circuit 64 for the EHC 36, the fuel addition valve 40, and the urea solution addition valve 42 in order to control the control amount (such as torque or exhaust components) of the internal combustion engine 10. Further, the controller 70 is configured to control the motor generator 50. The controller 70 operates the three-phase inverter 60 in order to control the control amount (such as output) of the motor generator 50. The controller 70 is powered by the low-voltage battery 68.

When controlling the control amount, the controller 70 refers to the pressure of the exhaust gas at the upstream side of the DPF 34 (upstream exhaust pressure Pu) detected by an output signal Scr of a crank angle sensor 80 and an upstream pressure sensor 82 and the pressure of the exhaust gas at the downstream side of the DPF 34 (downstream exhaust pressure Pd) detected by a downstream pressure sensor 84. Further, the controller 70 refers to the temperature of the exhaust gas flowing into the EHC 36 (exhaust temperature Tex) detected by an exhaust temperature sensor 86 and a charging/discharging current I of the high-voltage battery 62 detected by a current sensor 88. The controller 70 refers to an intake air amount Ga of the internal combustion engine 10 detected by an air flow meter 90, an accelerator operation amount ACCP detected by an accelerator sensor 92, and a vehicle speed SPD detected by a vehicle speed sensor 94. The controller 70 includes a CPU 72, a ROM 74, and a RAM 76. The controller 70 controls the above control amount when the CPU 72 executes a program stored in the ROM 74.

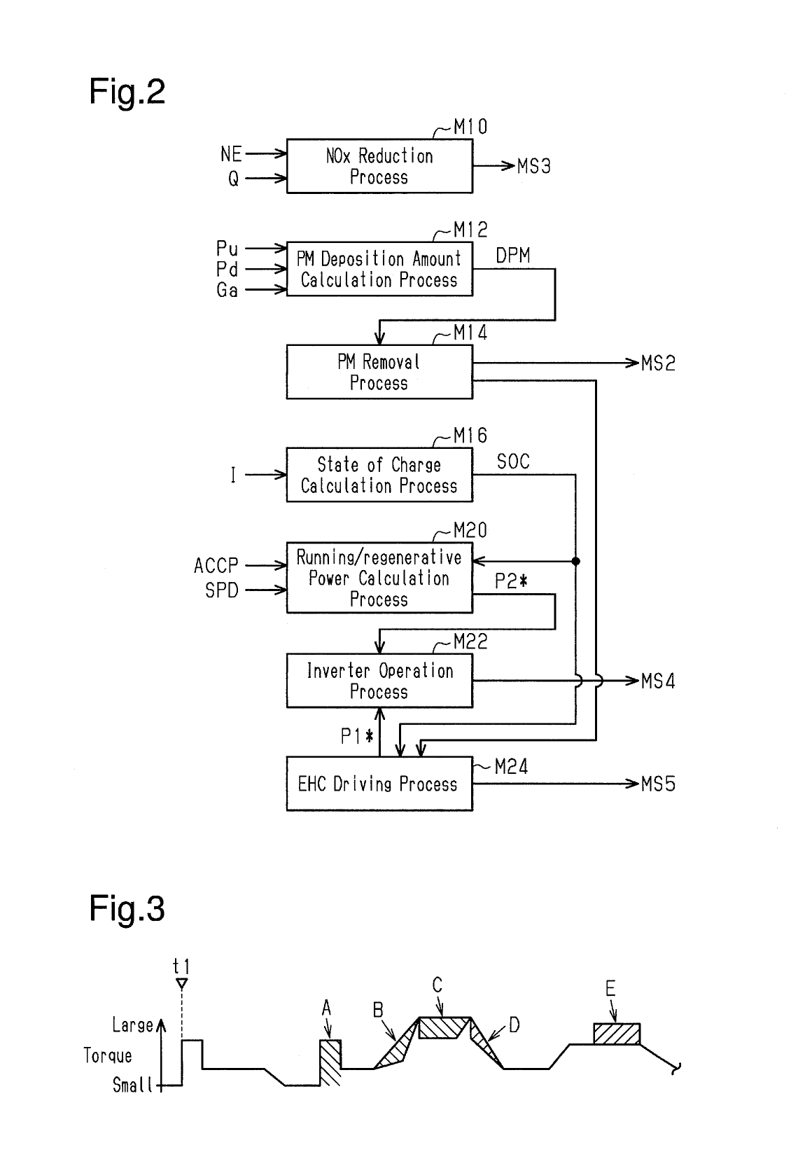

FIG. 2 shows some of the processes performed by the controller 70. The processes shown in FIG. 2 are performed when the CPU 72 executes the program stored in the ROM 74.

A NOx reduction process M10 is performed to operate the urea solution addition valve 42 and add a urea solution to the exhaust gas in accordance with the operation point of the internal combustion engine 10. The amount of urea solution added by the urea solution addition valve 42 is set to allow for sufficient reaction with the NOx in the exhaust gas. Specifically, the NOx reduction process M10 includes determining the amount of NOx in the exhaust gas based on the rotation speed NE of the crankshaft 26 serving as the operation point and an injection amount Q serving as a load and then calculating the amount of urea solution based on the rotation speed NE, the injection amount Q, and the NOx amount. The rotation speed NE is calculated by the CPU 72 on the basis of the output signal Scr.

A PM deposition amount calculation process M12 is performed to calculate and output the amount of PM collected in the DPF 34 (PM deposition amount DPM) based on the intake air amount Ga and a pressure difference ΔP obtained by subtracting the downstream exhaust pressure Pd from the upstream exhaust pressure Pu. The PM deposition amount calculation process M12 sets the PM deposition amount DPM to a larger value when the pressure difference ΔP is large than when the pressure difference ΔP is small. The PM deposition amount calculation process M12 sets the PM deposition amount DPM to a smaller value when the intake air amount Ga is large than when the intake air amount Ga is small. Specifically, the ROM 74 stores map data in which the pressure difference ΔP and the intake air amount Ga are input variables and the PM deposition amount DPM is an output variable. The CPU 72 performs map calculation to determine the PM deposition amount DPM based on the pressure difference ΔP and the intake air amount Ga. The map data is a set of data including discrete values of the input variables and values of the output variable corresponding to the input variables. Further, in the map calculation, if the values of the input variables match any of the values of the input variables in the map data, a corresponding value of the output values in the map data may be used as a calculation result. Further, in the map calculation, if the values of the input variables do not match any of the values of the input variables in the map data, a value obtained by interpolating values of a plurality of output variables included in the map data may be used as a calculation result.

A PM removal process M14 includes adding fuel from the fuel addition valve 40 to the exhaust gas on condition that the PM deposition amount DPM is greater than or equal to a specified amount. The PM removal process M14 is performed to remove PM by heating the DPF 34 and burning the PM. The DPF 34 is heated to a temperature required to perform a regeneration process (filter regeneration process) of the DPF 34 with the added fuel.

A state of charge calculation process M16 is performed to calculate a state of charge SOC of the high-voltage battery 62 by integrating the charging/discharging current I. The state of charge SOC of the high-voltage battery 62 is the ratio of a remaining charge level to a fully charged level.

A running/regenerative power calculation process M20 includes a running process for assisting the internal combustion engine 10 with the motor generator 50 when applying torque to the driving wheels 54. Further, the running/regenerative power calculation process M20 includes calculating required running/regenerative power P2*, which is the power required for a regeneration process that converts rotation power of the driving wheel 54 into electric power when the vehicle decelerates. FIG. 3 illustrates the running process and the regeneration process. With respect to the vertical axis of FIG. 3, portions that do not have a negative inclination indicate the required torque applied to the driving wheels 54, and portions that have a negative inclination indicate the required load torque applied to the driving wheels 54.

In range A of FIG. 3, a running process is performed when returning from what is referred to as an idle stop process, which is an automatic stop process of the internal combustion engine 10. In range B, a running process is performed during acceleration. In range C, a running process is performed with large torque (high load range) required for the driving wheel 54. In range D, a regeneration process is performed.

Returning to FIG. 2, an inverter operation process M22 is performed to set the power required for the motor generator 50 based on the required running/regenerative power P2* and the required EHC power P1* described below and to operate the three-phase inverter 60 such that an actual output becomes equal to the required power.

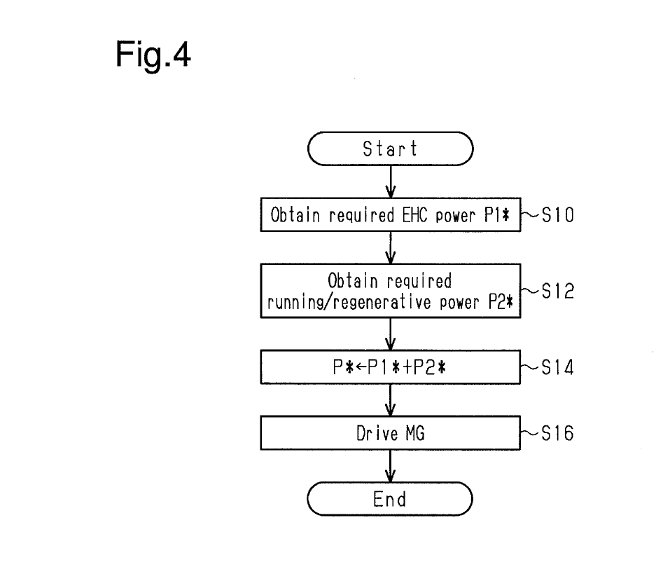

FIG. 4 shows the procedures of the inverter operation process M22. The process shown in FIG. 4 is performed when, for example, the CPU 72 repeatedly executes a program stored in the ROM 74 in predetermined cycle. In the description hereafter, steps are represented by numbers starting with “S.”

In the series of steps shown in FIG. 4, the CPU 72 first obtains the required EHC power P1* (S10) and then obtains the required running/regenerative power P2* (S12). The CPU 72 substitutes the sum of the required EHC power P1* and the required running/regenerative power P2* for a required power P* of the motor generator 50 (S14). Then, the CPU 72 outputs an operation signal MS4 to the three-phase inverter 60 to operate the three-phase inverter 60 such that the output of the motor generator 50 is controlled to be equal to the required power P* (S16). The CPU 72 temporarily ends the series of steps shown in FIG. 4 upon completion of the process of S16.

Returning to FIG. 2, an EHC driving process M24 is performed to calculate the required EHC power P1* and operate the driving circuit 64 such that power consumed by the EHC 36 is the required EHC power P1*.

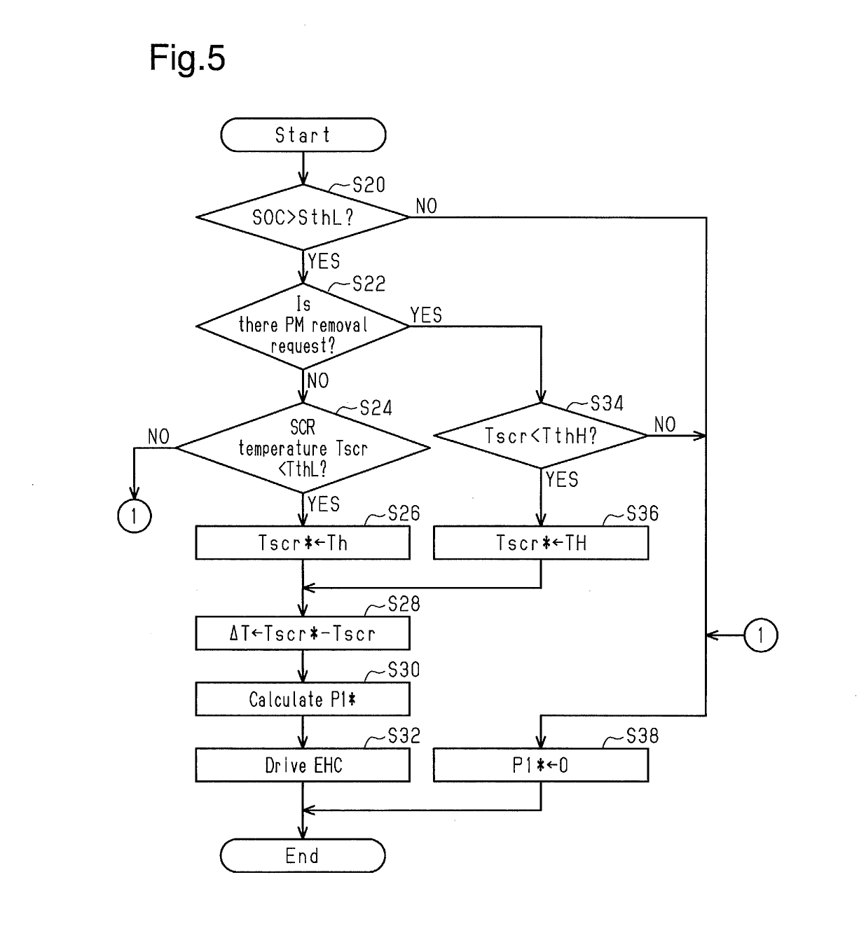

FIG. 5 shows the procedures of the EHC driving process M24. The process shown in FIG. 5 is performed when, for example, the CPU 72 repeatedly executes a program stored in the ROM 74 in predetermined cycle.

In the series of steps shown in FIG. 5, the CPU 72 first determines whether or not the state of charge SOC of the high-voltage battery 62 is greater than an allowable specified rate SthL (S20). If the CPU 72 determines that the state of charge SOC is greater than the specified rate SthL (YES in S20), the CPU 72 determines whether or not there is a PM removal request (S22). This process is performed to determine whether or not there is a PM removal request in the PM removal process M14 based on the PM deposition amount DPM. If the CPU 72 determines that there is no PM removal request (NO in S22), the CPU 72 determines whether or not the temperature of the SCR catalyst 38 (SCR temperature Tscr) is lower than a predetermined temperature TthL (S24). In this case, the SCR temperature Tscr is a value calculated by the CPU 72 by adding the increased amount of the temperature, which corresponds to the amount of heat generated by the EHC 36, to an exhaust temperature Tex. If heating control has not been performed on the EHC 36, the temperature increase amount is set to zero.

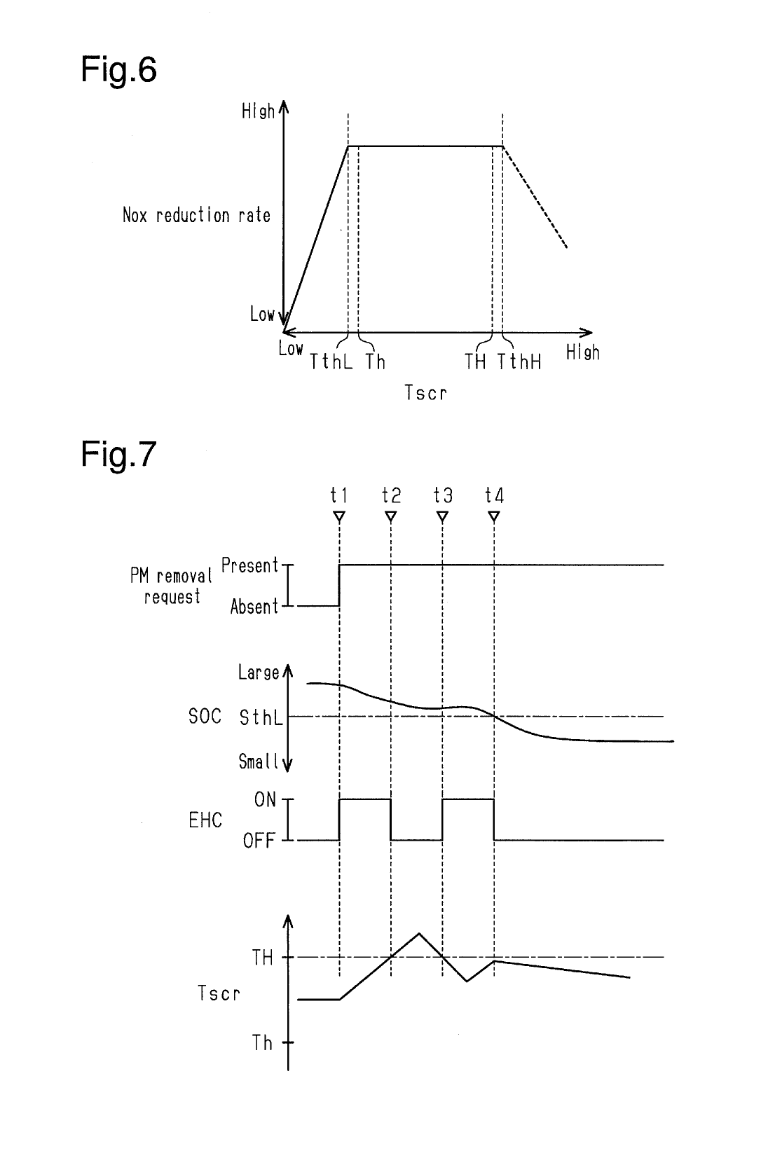

FIG. 6 shows the predetermined temperature TthL. As shown in FIG. 6, the predetermined temperature TthL is a lower limit temperature of the SCR temperature Tscr. The NOx reduction rate of the SCR catalyst 38 will fall greatly at temperatures lower than the predetermined temperature TthL. In this case, the NOx reduction rate is a value obtained by dividing a NOx amount reduced with the SCR catalyst 38 when adding an amount of urea solution that is suitable for reacting with the NOx in the exhaust gas by a NOx amount flowing into the SCR catalyst 38.

Returning to FIG. 5, if the CPU 72 determines that the SCR temperature Tscr is lower than the predetermined temperature TthL (YES in S24), the CPU 72 substitutes a normal target value Th for a target temperature Tscr* (S26). As shown in FIG. 6, a temperature higher than or equal to the predetermined temperature TthL is set to the normal target value Th. Returning to FIG. 5, the CPU 72 substitutes a value obtained by subtracting the SCR temperature Tscr from the target temperature Tscr* for a temperature difference ΔT (S28). Then, the CPU 72 calculates the required EHC power P1*, which is the power consumed by the EHC 36, as an operation amount to feedback-control the SCR temperature Tscr to the target temperature Tscr* based on the temperature difference ΔT (S30). Specifically, the CPU 72 calculates a larger required EHC power P1* when the temperature difference ΔT is large than when the temperature difference ΔT is small. In addition, when the temperature difference ΔT is less than or equal to zero, the CPU 72 sets zero to the required EHC power P1*. Then, the CPU 72 outputs an operation signal MS5 to the driving circuit 64 to operate the driving circuit 64 such that the power consumed by the EHC 36 is the required EHC power P1* (S32).

If the CPU 72 determines that there is a PM removal request (YES in S22), the CPU 72 determines whether or not the SCR temperature Tscr is lower than a specified temperature TthH (S34).

FIG. 6 shows the specified temperature TthH. As shown in FIG. 6, the specified temperature TthH is a value greater than the normal target value Th. The specified temperature TthH is an upper limit temperature at which the NOx reduction rate of the SCR catalyst 38 will drastically fall because of the high temperature when the SCR temperature Tscr is higher than or equal to the specified temperature TthH.

Returning to FIG. 5, if the CPU 72 determines that the SCR temperature Tscr is lower than a specified temperature TthH (YES in S34), the CPU 72 substitutes a reduction target value TH for the target temperature Tscr* (S36). As shown in FIG. 6, the reduction target value TH is a temperature higher than the normal target value Th and lower than or equal to the specified temperature TthH of the SCR temperature Tscr. Returning to FIG. 5, when the process of S36 is completed, the CPU 72 proceeds to the process of S28.

The CPU 72 substitutes zero for the required EHC power P1* when a negative determination is given in any of the processes of S20, S24, or S34 (S38).

The CPU 72 temporarily ends the series of steps shown in FIG. 5 if the process of S32 or S38 is completed.

The present embodiment has the following operations and advantages.

FIG. 7 shows whether there is a PM removal request, the state of charge SOC of the high-voltage battery 62, whether the EHC 36 is driven, and changes in the SCR temperature Tscr. As shown in FIG. 7, when a PM removal request is issued at time t1, the CPU 72 drives the EHC 36. This heats the SCR catalyst 38 and raises the SCR temperature Tscr. When the SCR temperature Tscr is raised to higher than or equal to the reduction target value TH at time t2, the CPU 72 stops the heating of the SCR catalyst 38 with the EHC 36. Then, when the SCR temperature Tscr becomes less than the reduction target value TH at time t3, the CPU 72 resumes heating of the SCR catalyst 38 with the EHC 36. FIG. 7 shows an example in which the heating of the SCR catalyst 38 with the EHC 36 is stopped because the state of charge SOC of the high-voltage battery 62 becomes less than or equal to the specified rate SthL at time t4.

In this manner, in the present embodiment, the power consumed by the EHC 36 is increased as much as possible by performing control, when a PM removal request is issued, raising the temperature of the SCR catalyst 38 as high as possible without declining the NOx reduction rate of the SCR catalyst 38. When the power consumed by the EHC 36 is increased, the power generated by the motor generator 50 is increased so that load torque applied by the motor generator 50 to the crankshaft 26 increases. The increased load torque on the internal combustion engine 10 increases the load torque even if the torque required for the driving wheels 54 is small, the load on the internal combustion engine 10 is not large because of the value of the required torque, and the exhaust temperature is not that high. Accordingly, the temperature of the exhaust gas discharged from the combustion chamber 20 to the exhaust passage 30 is raised, and the DPF 34 is heated to a high temperature such that PM is burned in cooperation with the fuel addition valve 40 that adds fuel to the exhaust gas.

If the load of the internal combustion engine 10 is high even though the EHC 36 is not driven, the temperature of exhaust gas will be high and the SCR temperature Tscr will be high. Thus, the CPU 72 will make a negative determination in the process of S34 and sets the required EHC power P1* to zero.

The present embodiment has the following advantage.

(1) A vehicle, to which the controller 70 is applied, includes the motor generator 50 that is configured to assist torque for assisting torque of the internal combustion engine 10. The EHC 36 is supplied with power when the motor generator 50 generates power. Since the motor generator 50 is configured to assist torque, the motor generator 50 tends to have a larger output than when an alternator is used as a generator for generating electric power through rotation power of the crankshaft 26. Thus, the motor generator 50 easily increases the load torque applied to the crankshaft 26.

### Correspondence

The correspondence of the items described in the above embodiment with the items described in the SUMMARY will now be described. The correspondence will be described with respect to each number in the SUMMARY.

In Example 1, the heater corresponds to the EHC 36. The filter corresponds to the DPF 34. The catalyst corresponds to the SCR catalyst 38. The generator corresponds to the motor generator 50. The increase process corresponds to the processes of S36 and S28 to S32.

In Example 3, the first temperature range corresponds to a temperature range proximate to the normal target value Th. The temperature adjustment process corresponds to the processes of S24 to S32.

The description in Example 4 corresponds to the shifting to the process of S38 when a negative determination is given in the process in S34.

### OTHER EMBODIMENTS

The present embodiment may be modified as follows. The present embodiment and the following modifications may be implemented in combination as long as there are no technical contradictions.

Regarding the Exhaust Purifier

In the above embodiment, the exhaust purifier includes the oxidation catalyst 32, the DPF 34, and the SCR catalyst 38. Instead, the exhaust purifier may include only the DPF 34 and the SCR catalyst 38. Further, the exhaust purifier may include, for example, a NOx occlusion reduction catalyst (NSR: NOx storage reduction) arranged at the upstream side of the DPF 34. Further, the exhaust purifier may include the DPF 34 and the NSR, and the SCR catalyst may be omitted from the exhaust purifier. In this case, the NSR may be arranged at the downstream side of the DPF 34, and the heated catalyst may be the NSR. However, the heated catalyst does not necessarily have to be arranged at the downstream side of the DPF 34.

Regarding the Increase Process

In the above embodiment, when a PM removal request is issued, power consumed by the EHC 36 is increased on condition that the state of charge SOC is greater than the specified rate SthL. Instead, this condition may be omitted if the state of charge SOC of the high-voltage battery 62 is expected to be greater than the specified rate SthL when the motor generator 50 generates electric power, which is greater than or equal to the power supplied to the EHC 36.

In the above embodiment, if the SCR temperature Tscr is higher than or equal to the specified temperature TthH, the heating process by the EHC 36 is not performed, or prohibited. Then, when the SCR temperature Tscr becomes less than the specified temperature TthH, the heating process by the EHC 36 is performed again. Alternatively, if the SCR temperature Tscr is higher than or equal to the specified temperature TthH and becomes lower than the specified temperature TthH, the heating process by the EHC 36 may be performed to limit hunting when the SCR temperature Tscr becomes lower than or equal to a predetermined temperature lower than the specified temperature TthH.

In the above embodiment, if the SCR temperature Tscr is raised to higher than or equal to the specified temperature TthH, the heating process by the EHC 36 is not performed, or prohibited. Instead, when the SCR temperature Tscr is raised to higher than or equal to the specified temperature TthH, the heating process may be performed and the amount of the added urea solution may be increased. In this case, for example, a NOx sensor may be arranged at the downstream side of the SCR catalyst 38. This modification is made by setting a correction amount for increasing the amount of urea solution to be added to an operation amount for performing feedback control using a detection value of the NOx sensor as a target value.

Regarding the PM Deposition Amount

In the above embodiment, the PM deposition amount DPM is calculated by performing a map calculation based on the pressure difference ΔP and the intake air amount Ga. Instead, for example, if the intake air amount Ga is greater than or equal to a specified value, the PM deposition amount DPM is calculated through the above map calculation. If the intake air amount Ga is less than the specified value, the PM deposition amount DPM may be estimated based on the rotation speed NE, the injection amount Q, and the temperature of coolant (coolant temperature THW) of the internal combustion engine 10.

This modification may be made as follows, for example. Specifically, the ROM 74 stores map data where the rotation speed NE and the injection amount Q are input variables and an amount of increase in PM deposition per unit time is an output variable. The ROM 74 also stores map data where the water temperature THW is an input variable and a water temperature correction coefficient is an output variable. After the CPU 72 performs map calculation to determine the increased amount of PM deposition, the CPU 72 multiplies the calculation result by the water temperature correction coefficient to correct the increased amount of PM deposition. This successively corrects the increased PM deposition amount DPM. In addition, if the intake air amount Ga that is greater than or equal to the specified value becomes less than the specified value, a value calculated based on the pressure difference ΔP may be set to an initial value of the PM deposition amount DPM. Further, if the intake air amount Ga that is less than the specified value becomes greater than or equal to the specified value, the PM deposition amount DPM may be calculated based on the pressure difference ΔP.

Regarding the Temperature Control of the SCR Catalyst 38 by the EHC 36

In the above embodiment, if a PM removal request is not issued, the SCR temperature Tscr is controlled to be equal to the normal target value Th. Instead, for example, the heating of the SCR catalyst 38 may be performed by the EHC 36 based on the assumption that a predetermined time after the internal combustion engine 10 starts to cool down is a period during which the temperature of the SCR catalyst 38 is lower than the first temperature range. In this case, the first temperature range is a predetermined temperature range greater than or equal to the predetermined temperature TthL and less than the reduction target value TH. Further, the heating of the SCR catalyst 38 may be performed based on the assumption that a period during which an integrated amount of air from when the cooling of the internal combustion engine 10 starts is less than a specified amount is a period in which the temperature of the SCR catalyst 38 is lower than the first temperature range.

Regarding the Temperature of the Selective Catalytic Reduction Catalyst

In the above embodiment, the SCR temperature Tscr is estimated. Instead, for example, a temperature sensor such as a thermocouple may be provided for the SCR catalyst 38 and a detection value of the temperature sensor may be used to estimate the SCR temperature Tscr.

Regarding the Generator

In the above embodiment, the motor generator 50 is used to generate the electric power consumed by the EHC 36. Instead, a vehicle may include a generator (such as an alternator) that does not function as an electric motor, and the electric power consumed by the EHC 36 may be generated by the generator.

Regarding the Controller for an Internal Combustion Engine

The controller for an internal combustion engine is not limited to a device that includes the CPU 72 and the ROM 74 and executes software processing. For example, at least part of the processes executed by the software in the above embodiment may be executed by hardware circuits (such as ASIC) dedicated to executing these processes. That is, the controller may be modified as long as it has any one of the following configurations (a) to (c). (a) A configuration including a processor that executes all of the above-described processes according to programs and a program storage device such as a ROM that stores the programs. (b) A configuration including a processor and a program storage device that execute part of the above-described processes according to the programs and a dedicated hardware circuit that executes the remaining processes. (c) A configuration including a dedicated hardware circuit that executes all of the above-described processes. A plurality of software processing circuits each including a processor and a program storage device and a plurality of dedicated hardware circuits may be provided. That is, the above processes may be executed in any manner as long as the processes are executed by processing circuitry that includes at least one of a set of one or more software processing circuits and a set of one or more dedicated hardware circuits.

Therefore, the present examples and embodiments are to be considered as illustrative and not restrictive and the disclosure is not to be limited to the examples and embodiments given herein.

1. A controller for an internal combustion engine, wherein the controller is configured to be used in a vehicle to control the vehicle, the vehicle includes an internal combustion engine that is provided with an exhaust purifier and a generator that converts rotation power of a crankshaft of the internal combustion engine into electric power, the exhaust purifier includes a heater configured to generate heat by consuming electric power, a filter configured to collect particulate matter from an exhaust gas, and a catalyst arranged at an upstream side or downstream side of the filter and subjected to heating by the heater,
wherein the controller is configured to perform an increase process that increases electric power generated by the generator by increasing electric power consumed by the heater on condition that a regeneration request for the filter is issued.

2. The controller according to claim 1, wherein
the catalyst is arranged at the downstream side of the filter, and
the heater is arranged between the filter and the catalyst.

3. The controller according to claim 2, wherein
the catalyst is a selective catalytic reduction catalyst configured to reduce NOx,
the controller is configured to perform a temperature adjustment process that supplies electric power to the heater in order to control a temperature of the selective catalytic reduction catalyst within a first temperature range in a case in which the temperature of the selective catalytic reduction catalyst is lower than the first temperature range, and
the increase process includes controlling the temperature of the selective catalytic reduction catalyst to be higher than the first temperature range.

4. The controller according to claim 3, wherein the controller is configured to be prohibited from performing the increase process in a case in which the temperature of the selective catalytic reduction catalyst is higher than or equal to a specified temperature, which is higher than the first temperature range.

5. The controller according to claim 1, wherein the generator includes a motor generator that is configured to assist torque for assisting torque of the internal combustion engine.
